(19) United States
(12) Patent Application Publication
(10) Pub. No.: US 2012/0022745 A1
(43) Pub. Date: Jan. 26, 2012

(54) METHOD FOR OPERATING A STEERING SYSTEM

(75) Inventor: Georg von Tardy-Tuch, Kapfenhardt (DE)

(73) Assignee: Dr. Ing. h.c. F. Porsche Aktiengesellschaft, Stuttgart (DE)

(21) Appl. No.: 13/182,569

(22) Filed: Jul. 14, 2011

(30) Foreign Application Priority Data
Jul. 26, 2010 (DE) 102010036619.6

(51) Int. Cl. B62D 6/00

(52) U.S. Cl. 701/42

(57) ABSTRACT

A method for operating a steering system, a steering system of this type and a steering device of a vehicle are disclosed herein. The vehicle has a front axle and a rear axle, a slip angle of the front axle being influenced by steering of the rear axle in such a way that the slip angle remains constant over a steering wheel angular range.

### CROSS-REFERENCE TO RELATED APPLICATION

This U.S. patent application claims priority to German Patent Application DE 102010036619.6, filed Jul. 26, 2010, which is incorporated by reference herein in its entirety.

### FIELD OF THE INVENTION

The invention relates to a method for operating a steering system, to a steering system of this type, and to a steering device.

### BACKGROUND OF THE INVENTION

The proposed method is used in a steering system having a steering assistance means which can be influenced in an active manner, such as EPS or Servotronic. The aim in steering systems of this type is to achieve an increase in the driving safety, in particular when driving around bends. To this end, an examination is carried out as to which forces act on a steered wheel, in order for it to be possible to describe its behavior in different driving situations.

In order to illustrate the forces which occur at a steered wheel in different driving situations, what is known as Kamm's circle is used, for example, which is a graphical representation for dividing up the overall possible force at the wheel. Here, the cornering force in the transverse direction and the braking force or the propulsion in the longitudinal direction of the wheel until the maximum adhesion is reached are taken into consideration. Kamm's circle makes it clear that longitudinal forces and cornering forces depend on one another. The resulting overall force cannot exceed the maximum available adhesion. It follows that less cornering force is available if the longitudinal force is increased. Conversely, it is true that a maximum acceleration or retardation is possible only when driving in a straight line.

A tire delivers the maximum acceleration values on Kamm's circle. A skilled driver can detect this with regard to the front axle using the manual forces which occur. The latter first of all increase as the steering angle increases. They fall again when the maximum is exceeded; the cornering force potential of the axle is then likewise exhausted. The bend radius is increased again if further lock is applied.

Document EP 2 065 291 A1, which is incorporated by reference herein, describes a method for influencing the driving dynamics of a motor vehicle which is equipped with a power steering system. An increase in the driving safety when driving around bends is to be achieved by way of the proposed method. To this end, an additional steering angle is introduced, a setpoint stipulation for this angle being determined by way of a control and regulating unit. If an understeering state is detected, the setpoint stipulation of the additional steering angle is modified to the extent that the cornering force is maintained during the understeering state in a range of a maximum possible cornering force value which is a function of environmental influences.

### SUMMARY OF THE INVENTION

It is an object of the present invention to increase the driving safety in a vehicle, in particular in a vehicle which is equipped with a power steering system.

According to aspects of the invention, this object is achieved by a method for operating a steering system of a vehicle having a front axle and a rear axle, in which method a slip angle of the front axle is influenced, the slip angle of the front axle being influenced by steering of the rear axle in such a way that said slip angle remains constant over a steering wheel angular range.

According to aspects of the invention, this object is also achieved by a steering device of a vehicle having a front axle and a rear axle, which steering device acts on the rear axle of the vehicle, a unit being provided for detecting a slip angle of the front axle, and the steering device being configured in such a way that it influences the slip angle of the front axle by steering of the rear axle in such a way that said slip angle remains constant over a steering wheel angular range.

The described method serves to operate a steering system of a vehicle having a front axle and a rear axle, a slip angle of the front axle being influenced. Here, the influencing is brought about by steering of the rear axle, to be precise in such a way that the slip angle remains constant over a steering wheel angular range.

The possibility is therefore utilized of influencing the slip angle of the front axle in an active manner in combination with the rear axle.

Here, the slip angle is understood as meaning the angle between the direction in which a wheel points and the direction in which the wheel actually moves on the roadway.

There is then provision in the method, when the maximum cornering force is reached, for the slip angle to be kept constant at least over a limited steering wheel angular range. One possible course of action is as follows:

The driver steers, and the slip angle and the cornering force are built up. The maximum with regard to the cornering force is reached. Despite further application of lock, the slip angle remains constant, and the rear axle steering compensates for this oversteer. The potential of the rear axle steering for compensation is achieved; the slip angle continues to increase, but the transverse force decreases.

At the same time, the driver can be given the feeling of the maximum transverse force being exceeded by adaptation of the steering assistance means. As a result, it is also possible for a less skilled driver to detect exceeding of the maximum cornering force before this range is left.

Furthermore, a steering device of a vehicle having a front axle and a rear axle is described, which steering device acts on the rear axle of the vehicle. In the case of the steering device, a unit is provided for detecting the slip angle of the front axle. The steering device is configured or set up in such a way that it influences the slip angle of the front axle by steering of the rear axle in such a way that said slip angle remains constant over a steering wheel angular range.

It is expedient if a first device is provided for determining the coefficient of friction and/or a second device is provided for determining the rack force.

The proposed steering system of a vehicle having a front axle and a rear axle and a steering assistance means which can be influenced in an active manner comprises a steering device of the type described above and therefore a rear axle steering system. The steering system is suitable, in particular, for carrying out the method described.

For the implementation of the proposed method, a steering system with a steering assistance means which can be influenced in an active manner, such as an electronic power steering system or EPS, Servotronic, etc., a means for determining the coefficient of friction or a means for determining the rack force and a rear axle steering system are routinely required.

### BRIEF DESCRIPTION OF THE DRAWINGS

Further advantages and refinements of the invention result from the description and the appended drawing.

It goes without saying that the features which are mentioned above and are still to be explained below can be used not only in the respectively specified combination, but also in other combinations or on their own, without departing from the scope of the present invention.

FIG. 1 shows a diagrammatic illustration of a vehicle having a steering device according to aspects of the invention.

FIG. 2 shows profiles of forces which act when driving around bends.

### DETAILED DESCRIPTION OF THE PREFERRED EMBODIMENTS

The invention is shown using embodiments in the figures and will be described with reference to the figures.

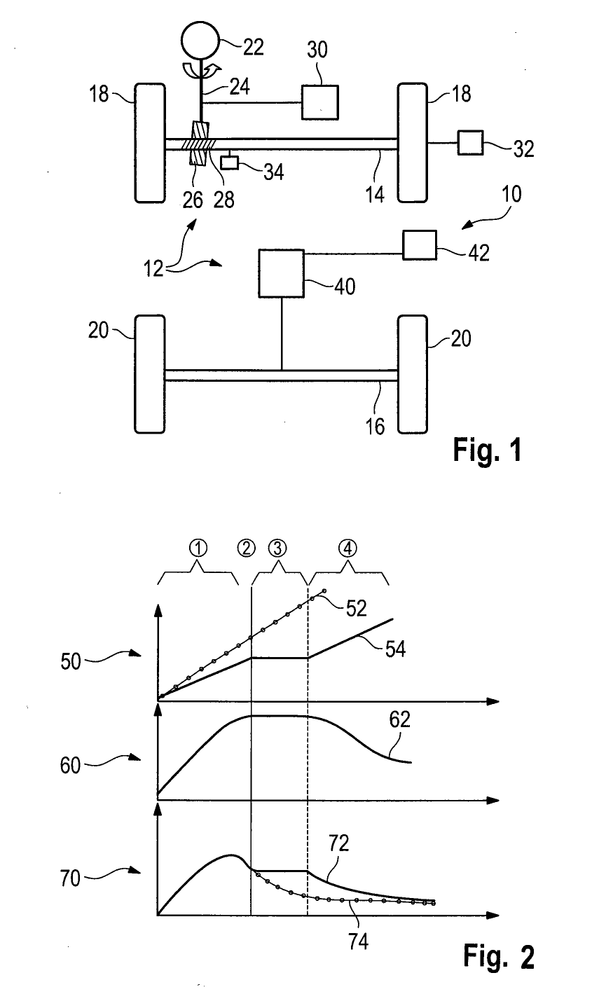

FIG. 1 shows a vehicle, denoted overall by the designation 10. The vehicle 10 comprises a steering system 12, by way of which a front axle 14 and a rear axle 16 are to be controlled. Here, both wheels 18 which are steered on the front axle 14 and wheels 20 which are steered on the rear axle 16 are provided.

A steering wheel 22, a steering column 24, a steering pinion 26 and a rack 28 are provided for direct control of the front axle 14. The driver introduces a manual moment via the steering wheel 22, which manual moment is transmitted via the steering column 24 and the steering pinion 26 to the rack 28. The steering column 24 can be a mechanical, hydraulic or electric steering column. Furthermore, the representation shows a steering assistance means 30 which applies a moment which is superimposed on the manual moment which is applied by the driver, and a first device 32 for determining the coefficient of friction and a second device 34 for determining the rack force.

Furthermore, the steering system 12 comprises a steering device 40 which acts on the rear axle 16 and interacts with a unit 42 for detecting the slip angle of the front axle 14. This achieves a situation where the slip angle of the front axle 14 is influenced in an active manner by steering of the rear axle 16. Said slip angle can therefore be kept constant, and oversteer can be compensated for.

FIG. 2 shows three graphs arranged above one another. Here, the profile of a steering angle 52 and the profile of a slip angle 54 are plotted in a first graph 50. The profile of the lateral force 62 is shown in a second graph 60. The profile of the manual force without active correction 72 and the profile of the manual force with active correction 74 are plotted in a third graph 70.

FIG. 2 shows four ranges which are labeled by the numerals 1, 2, 3 and 4. A possible sequence according to the method in accordance with the invention is clarified with the aid of this division. Said possible sequence is as follows:

1) The driver steers (rising profile 52), and the slip angle 54 and the cornering force 62 are built up.

2) The maximum with regard to the cornering force 62 is reached.

3) Despite further application of lock, the slip angle 54 remains constant, and the rear axle steering compensates for this oversteer.

4) The potential of the rear axle steering for compensation is achieved; the slip angle 54 continues to increase, but the transverse force decreases.

1.-9. (canceled)

10. A method for operating a steering system of a vehicle having a front axle and a rear axle, in which method a slip angle of the front axle is influenced, the slip angle of the front axle being influenced by steering of the rear axle in such a way that the slip angle remains constant over a steering wheel angular range.

11. The method as claimed in claim 10, in which a steering assistance means of the steering system is adapted in such a way that exceeding of a maximum transverse force is imparted to the driver.

12. The method as claimed in claim 10, in which a determination of the coefficient of friction is carried out.

13. The method as claimed in claim 10, in which a determination of the rack force is carried out.

14. A steering device of a vehicle having a front axle and a rear axle, which steering device acts on the rear axle of the vehicle, and
a unit for detecting a slip angle of the front axle,
wherein the steering device is configured in such a way that it influences the slip angle of the front axle by steering of the rear axle in such a way that the slip angle remains constant over a steering wheel angular range.

15. The steering device as claimed in claim 14 further comprising a first device for determining a coefficient of friction.

16. The steering device as claimed in claim 14 further comprising a second device for determining a rack force.

17. A steering system of a vehicle having a front axle and a rear axle and a steering assistance means which is configured to be influenced in an active manner, which steering system has a steering device as claimed in claim 14.

18. The steering system as claimed in claim 17, wherein the steering assistance means is an electronic power steering system that is configured to be influenced in an active manner.
